(19) United States
(12) Patent Application Publication
(10) Pub. No.: US 2026/0036490 A1
(43) Pub. Date: Feb. 5, 2026

(54) VIBRATION DETECTION DEVICE, ABNORMALITY DETECTION ASSISTANCE SYSTEM, AND VIBRATION DETECTION METHOD

(71) Applicant: NSXe Co. LTD, Suzuka-shi, Mie (JP)

(72) Inventors: Shoji SUZUKI, Suzuka-shi (JP); Shinji NAKAYAMA, Suzuka-shi (JP)

(73) Assignee: NSXe Co. LTD, Suzuka-shi, Mie (JP)

(21) Appl. No.: 18/874,532

(22) PCT Filed: Sep. 12, 2022
(86) PCT No.: PCT/JP2022/034065

§ 371 Date: Oct. 13, 2025

(51) Int. Cl. G01M 13/045

(52) U.S. Cl. CPC G01M 13/045

(57) ABSTRACT

A vibration detection device includes a vibration detector that detects vibration generated in a rolling bearing and converts the vibration into an analog signal and a sampler that performs sampling on the analog signal to convert the analog signal into a digital signal. In the vibration, a repeating unit including a first vibration section in which vibration occurs at a predetermined first frequency and a second section following the first vibration section is repeated at a predetermined repetition period, when a flaw is generated in the rolling bearing, and the sampler performs sampling on the analog signal at a sampling frequency lower than twice the first frequency.

### TECHNICAL FIELD

The present invention relates to a vibration detection device, an abnormality detection assistance system, and a vibration detection method, for detecting abnormality of a rolling bearing.

### BACKGROUND ART

Conventionally, there is known an abnormality identification device that identifies abnormality in a bearing by attaching a vibration detection element to a bearing device of a railway vehicle, sampling a detected vibration signal, obtaining an envelope, and performing frequency analysis by FFT on the envelope (for example, see paragraphs 0025 and 0026 of Patent Literature 1 (PTL 1)).

According to the description in paragraph 0026 of PTL 1, since the maximum frequency that can undergo Fourier transform (Nyquist frequency) is determined according to the sampling time, it is preferable that a frequency equal to or higher than the Nyquist frequency be not included in a vibration signal. The Nyquist frequency is a frequency of ½ of the sampling frequency. Therefore, the sampling frequency needs to be at least twice the highest frequency included in the vibration signal, in order to prevent a frequency equal to and above the Nyquist frequency from being contained in the vibration signal.

### CITATIONS LIST

### Patent Literature

PTL 1: Japanese Unexamined Patent Application Publication No. 2004-212225

### SUMMARY OF INVENTION

However, sampling at a sampling frequency that is twice or more the highest frequency included in the vibration signal increases costs for members such as sensors and an analog-digital converter, which perform the sampling, resulting in increasing the cost for a vibration detection device for detecting vibration.

An object of the present invention is to provide a vibration detection device, an abnormality detection assistance system, and a vibration detection method, which can easily reduce the cost of a vibration detection device for detecting abnormality in a rolling bearing.

A vibration detection device according to an aspect of the present invention includes: a vibration detector that detects vibration generated in a rolling bearing and converts the vibration into an analog signal; and a sampler that performs sampling on the analog signal to convert the analog signal into a digital signal. In the vibration, a repeating unit including a first vibration section in which vibration occurs at a predetermined first frequency and a second section following the first vibration section is repeated at a predetermined repetition period, when a flaw is generated in the rolling bearing, and the sampler performing the sampling on the analog signal at a sampling frequency lower than twice the first frequency.

An abnormality detection assistance system according to an aspect of the present invention includes: a digital signal acquisitor that acquires the digital signal from the vibration detection device described above; an envelope detector that detects an envelope of a vibration waveform based on the digital signal; and a frequency analyzer that performs frequency analysis on the envelope to calculate an analysis value for each frequency component.

A vibration detection method according to an aspect of the present invention includes: detecting vibration generated in a rolling bearing and converting the vibration into an analog signal; and sampling the analog signal to convert the analog signal into a digital signal. In the vibration, a repeating unit including a first vibration section in which vibration occurs at a predetermined first frequency and a second section following the first vibration section is repeated at a predetermined repetition period, when a flaw is generated in the rolling bearing, and in the sampling, the analog signal is sampled at a sampling frequency lower than twice the first frequency.

### BRIEF DESCRIPTION OF DRAWINGS

FIG. 1 is a block diagram illustrating an example of an abnormality detection assistance system including a vibration detection device according to an embodiment of the present invention.

FIG. 2 is a block diagram illustrating an example of an electrical configuration of the abnormality detection assistance system illustrated in FIG. 1.

FIG. 3 is an explanatory diagram illustrating an example of a flow of processing of the abnormality detection assistance system.

FIG. 4 is a waveform diagram illustrating a typical example of an analog signal indicating vibration in a case where a flaw is generated in a rolling bearing.

FIG. 5 is an enlarged diagram of a repeating unit illustrated in FIG. 4.

FIG. 6 is an explanatory diagram for describing the structure of the rolling bearing.

FIG. 7 is an explanatory diagram for describing sampling performed by a sampler.

FIG. 8 is an explanatory diagram for describing folding caused by the sampling.

FIG. 9 is a waveform diagram illustrating an example of an envelope waveform.

FIG. 10 is an explanatory diagram illustrating an analysis value for each frequency component in a graph.

### DESCRIPTION OF EMBODIMENTS

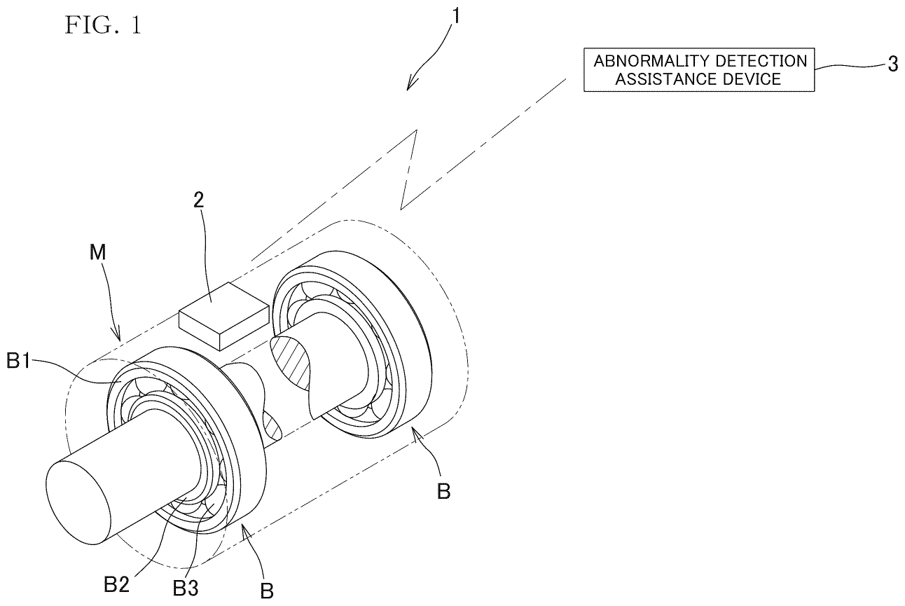

Hereinafter, embodiments according to the present invention will be described with reference to the drawings. In the drawings, components with the same reference signs have the same configuration, and the description of the same component may be omitted. FIG. 1 is a block diagram illustrating an example of an abnormality detection assistance system including a vibration detection device according to an embodiment of the present invention.

An abnormality detection assistance system 1 illustrated in FIG. 1 includes a vibration detection device 2 and an abnormality detection assistance device 3. The vibration detection device 2 is attached to, for example, a housing of a motor M including a rolling bearing B as an abnormality detection target. Alternatively, the vibration detection device 2 may be attached to a housing or the like of a mechanical device including the motor M. The vibration detection device 2 can detect vibration generated in the rolling bearing B when attached to the motor M or the like including the rolling bearing B.

The rolling bearing B includes an outer ring B1, an inner ring B2, and a rolling element B3. Note that the rolling bearing B is not limited to being used for the motor M, and may be used for various applications, and the vibration detection device 2 is merely required to be attached to a part to which vibration generated in the rolling bearing B is transmitted.

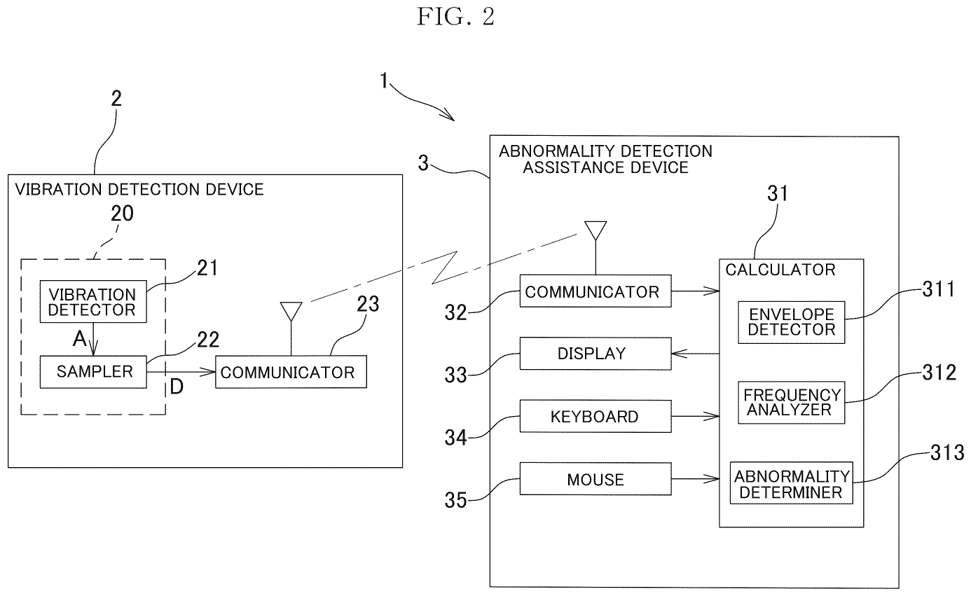

FIG. 2 is a block diagram illustrating an example of an electrical configuration of the abnormality detection assistance system 1 illustrated in FIG. 1. The abnormality detection assistance system 1 illustrated in FIG. 2 includes the vibration detection device 2 and the abnormality detection assistance device 3.

The vibration detection device 2 includes a vibration detector 21, a sampler 22, and a communicator 23. The vibration detector 21 and the sampler 22 may be integrally configured as, for example, an acceleration sensor 20 or the like.

The vibration detector 21 detects vibration, converts the vibration into an analog signal A, and outputs the analog signal A to the sampler 22. The vibration detector 21 may detect vibration as acceleration, may detect vibration in one axis, or may detect vibration in the X-axis, Y-axis, and Z-axis directions orthogonal to each other and output analog signals Ax, Ay, and Az representing the vibration in the X-axis, Y-axis, and Z-axis directions to the sampler 22 as an analog signal A.

The acceleration corresponds to an example of information indicating vibration. Note that the vibration detector 21 only needs to be capable of detecting vibration, and is not limited to detect vibration on the basis of acceleration. For example, the vibration detector 21 may detect vibration on the basis of a velocity or may detect vibration on the basis of displacement.

The sampler 22 samples the analog signal A to convert it into a digital signal D, and outputs the digital signal D to the communicator 23. The sampler 22 is configured as, for example, an analog-digital converter. The sampler 22 samples the analog signal A at a sampling frequency Fs.

The communicator 23 is a communication interface circuit capable of wirelessly communicating with the abnormality detection assistance device 3. The communicator 23 transmits the digital signal D to the abnormality detection assistance device 3 through wireless communication.

The abnormality detection assistance device 3 is configured using, for example, a personal computer. The abnormality detection assistance device 3 includes, for example, a calculator 31, a communicator 32 (digital signal acquisitor), a display 33, a keyboard 34, and a mouse 35.

The communicator 32 is a communication interface circuit capable of wirelessly communicating with the communicator 23 of the vibration detection device 2. The communicator 32 acquires the digital signal D transmitted from the vibration detection device 2 and transmits the digital signal D to the calculator 31. As communication methods of the communicators 23 and 32, various wireless communication methods such as WiFi (registered trademark) and Bluetooth (registered trademark) can be used.

Note that the communicators 23 and 32 are not limited to the example of performing wireless communication, and may perform wired communication. Alternatively, the digital signal D output from the sampler 22 may be stored in a storage medium such as a memory card and read by the abnormality detection assistance device 3, so that the abnormality detection assistance device 3 acquires the digital signal D. In this case, a reading device that reads the storage medium corresponds to an example of the digital signal acquisitor.

The vibration detection device 2 and the abnormality detection assistance device 3 may be configured as one integrated device. In this case, the communicators 23 and 32 are not necessary, and the digital signal D output from the sampler 22 may be directly or indirectly input to the calculator 31. In this case, the calculator 31 corresponds to an example of the digital signal acquisitor.

The calculator 31 is configured using, for example, a microcomputer. The calculator 31 includes, for example, a central processing unit (CPU) that performs predetermined arithmetic processing, a random access memory (RAM) that temporarily stores data, a nonvolatile storage device such as a hard disk drive (HDD) or a solid state drive (SSD), and peripheral circuits for these components.

Then, the calculator 31 functions as an envelope detector 311, a frequency analyzer 312, and an abnormality determiner 313 by, for example, executing an abnormality detection assistance program stored in advance in the above-described storage device.

The envelope detector 311 detects an envelope of a vibration waveform based on the digital signal D.

The frequency analyzer 312 performs frequency analysis on the envelope detected by the envelope detector 311 and calculates an analysis value for each frequency component.

The abnormality determiner 313 determines that there is an abnormality when the magnitude of the analysis value for each frequency component calculated by the frequency analyzer 312 exceeds a preset reference value in a reference frequency range corresponding to a frequency range including a repetition frequency Fr that is a reciprocal of a repetition period Tr to be described below.

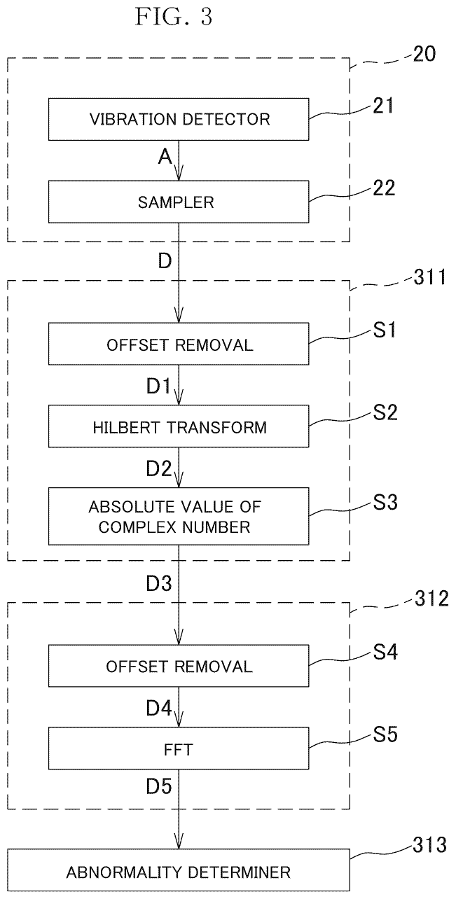

Next, an operation of the abnormality detection assistance system 1 illustrated in FIG. 1 will be described. FIG. 3 is an explanatory diagram illustrating an example of a flow of processing in the abnormality detection assistance system 1. In FIG. 3, transmission and reception of the digital signal D by the communicators 23 and 32 are not illustrated.

First, the vibration detector 21 detects vibration generated in the rolling bearing B, converts the vibration into an analog signal A, and outputs the analog signal A to the sampler 22.

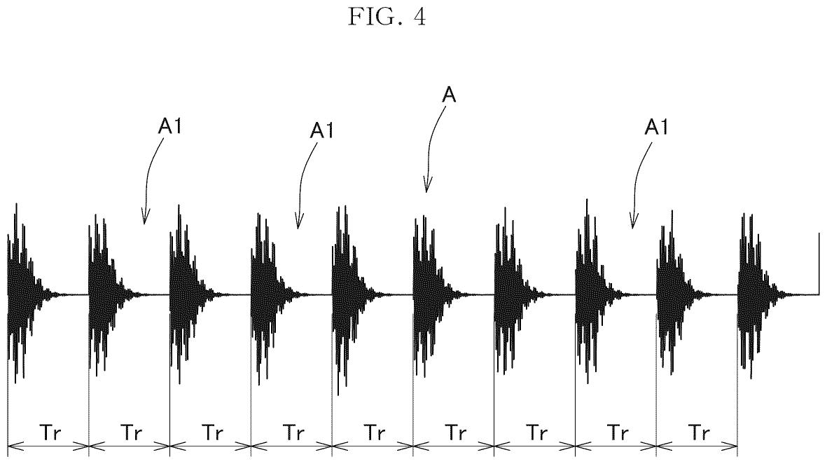

FIG. 4 is a waveform diagram illustrating a typical example of the analog signal A indicating vibration in a case where a flaw is generated in the rolling bearing B. It is known that in a case where a flaw is generated in the rolling bearing B, a vibration waveform obtained includes a repeating unit A1 repeated at an interval of the repetition period Tr as illustrated in FIG. 4.

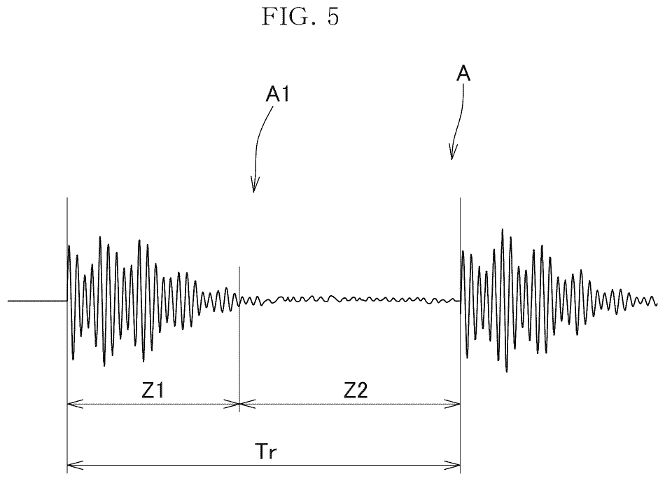

FIG. 5 is an enlarged diagram of an example of the repeating unit A1 illustrated in FIG. 4. The repeating unit A1 includes a first section Z1 in which vibration is generated at a first frequency F1 and a second section Z2 that follows the first section Z1. The second section Z2 is a section in which the vibration in the first section Z1 converges. The amplitude of the analog signal A in the second section Z2 is, for example, 1/10 or less of the maximum amplitude of the analog signal A in the first section Z1.

The frequency of the analog signal A in the first section Z1 is the first frequency F1. When the frequency of the analog signal A varies in the first section Z1, the maximum frequency of the variation range may be set as the first frequency F1.

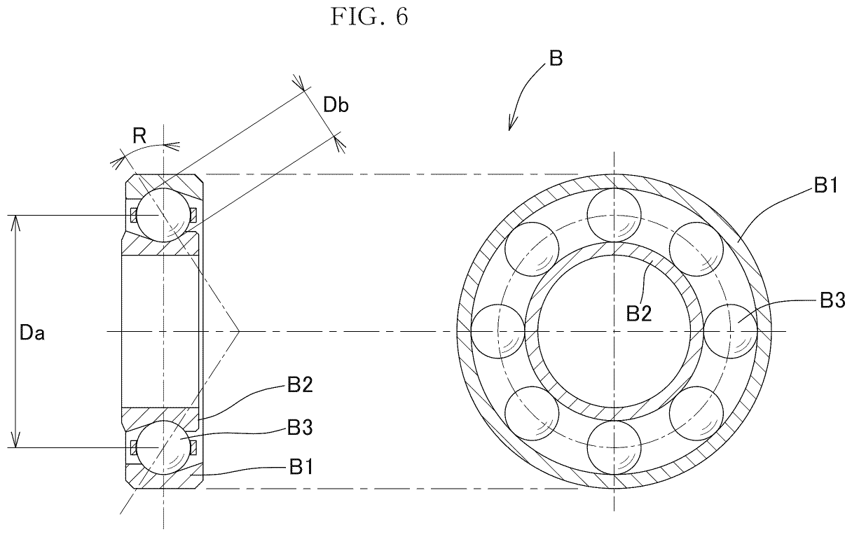

It is known that the repetition frequency Fr, which is the reciprocal of the repetition period Tr, is determined by the structure of the rolling bearing B, the rotational speed, and the position of the flaw. FIG. 6 is an explanatory diagram for describing the structure of the rolling bearing B. When the rotation frequency of the rolling bearing B is defined as Fb, the pitch diameter of the rolling bearing B is defined as Da, the diameter of the rolling element B3 is defined as Db, the contact angle of the rolling element B3 is defined as R, and the number of rolling elements is defined as N, the repetition frequencies Fr in a case where flaws are generated in the outer ring B1 and the inner ring B2 are expressed by the following formulas (1) and (2), respectively.

Repetition frequency in a case where a flaw is generated in an outer ring B1: Fr=(N/2)×Fb×{1−(Db/Da)cos R} (1)

Repetition frequency in a case where a flaw is generated in an inner ring B2:Fr=(N/2)×Fb×{1+(Db/Da)cos R} (2)

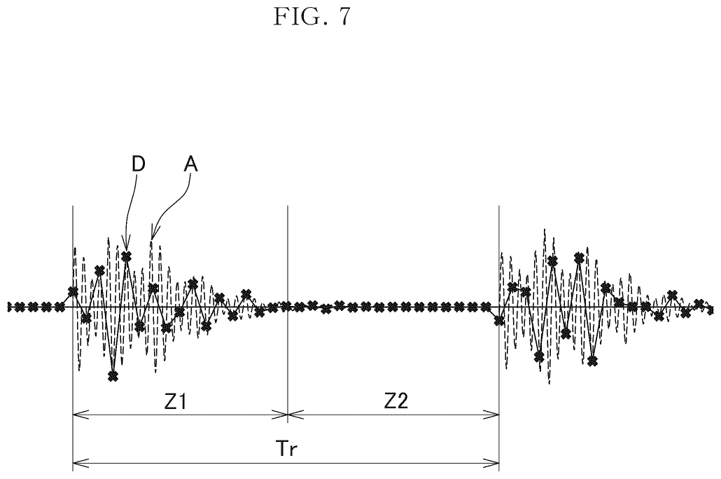

Referring to FIG. 3, the sampler 22 subsequently samples the analog signal A at the sampling frequency Fs to convert the analog signal A into the digital signal D. FIG. 7 is an explanatory diagram for describing sampling performed by the sampler 22. In FIG. 7, the waveform of the analog signal A is indicated by a broken line, and the waveform of the digital signal D is indicated by a solid line. The sampling points are indicated by × marks.

The sampling frequency Fs is lower than twice the first frequency F1 that is the frequency of the analog signal A in the first section Z1. Therefore, the sampling frequency Fs is in a state of undersampling relative to the analog signal A in the first section Z1.

A sampling period Ts that is a reciprocal of the sampling frequency Fs is shorter than ½ of the repetition period Tr. Therefore, the sampling frequency Fs is higher than twice the repetition frequency Fr. The sampling frequency Fs is desirably as high as possible within a range lower than twice the first frequency F1. For example, it is more preferable that the sampling period Ts be shorter than ¼ of the repetition period Tr, and the sampling frequency Fs be higher than four times the repetition frequency Fr.

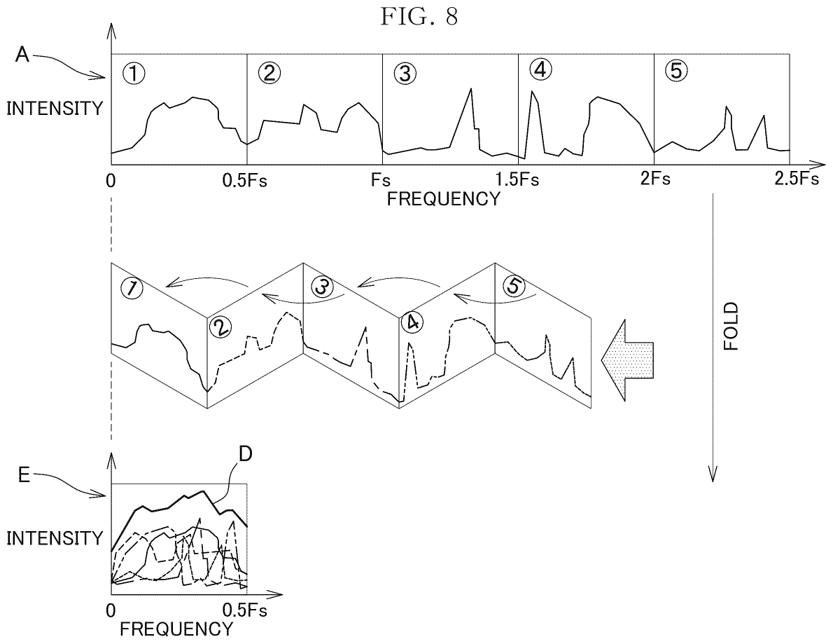

FIG. 8 is an explanatory diagram for describing folding caused by sampling the analog signal A at the sampling frequency Fs lower than twice the first frequency F1. In FIG. 8, the analog signal A is represented by a frequency spectrum with a horizontal axis representing a frequency and a vertical axis representing a signal intensity. 0.5Fs is the Nyquist frequency.

As illustrated in FIG. 8, a portion of the analog signal A representing vibration, in which a frequency is higher than the Nyquist frequency (0.5Fs), is folded to a frequency lower than the Nyquist frequency (0.5Fs) and sampled. As a result, as illustrated in a folded diagram E, the signals having different frequencies overlap with each other, and the sum of the intensities of the signals becomes the waveform indicated by the sampled digital signal D.

As described above, when signals of different frequencies are folded and overlapped, the frequency, waveform, and the like of the vibration signal cannot be correctly grasped, causing conventionally called “folding noise” or the like, and measures for preventing such folding have been required. However, since the abnormality detection assistance system 1 detects the envelope, i.e., the entire intensity change, the sum of the intensities of signals of a plurality of frequencies can be regarded as the intensity of a signal of one frequency without any problem.

Next, the envelope detector 311 performs offset removal processing of removing a DC component not to be analyzed from the digital signal D generated by sampler 22 to generate a sampling waveform D1 (step S1). If an offset is in the signal waveform represented by the digital signal D, the shape of the envelope (envelope) is changed. Therefore, a target waveform cannot be obtained. As a result, the detection sensitivity for abnormality detection decreases. Therefore, the envelope detector 311 preferably performs offset removal processing (step S1).

Next, the envelope detector 311 performs, for example, Hilbert transform (step S2) on the sampling waveform D1 to acquire an envelope of the signal waveform represented by the sampling waveform D1, and generates an envelope waveform D2 representing the envelope.

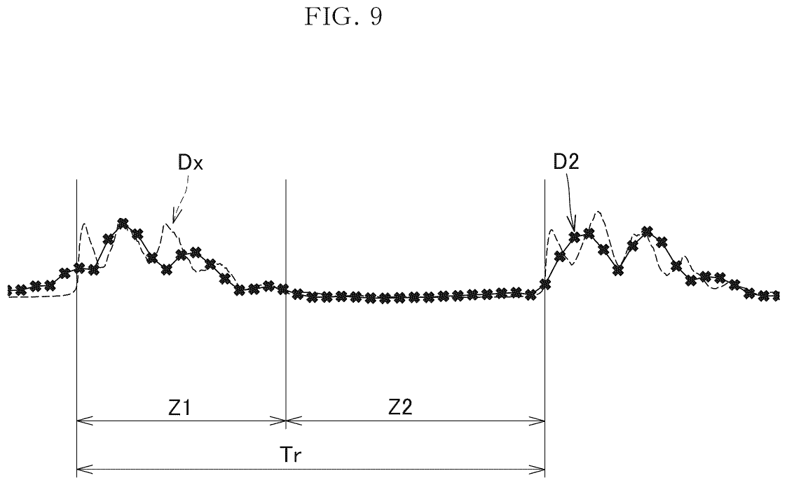

FIG. 9 is a waveform diagram illustrating an example of the envelope waveform D2. In FIG. 9, the envelope waveform D2 is indicated by a solid line, and an envelope waveform Dx obtained when sampling is performed with the sampling frequency Fs set to twice or more the first frequency F1 is indicated by a broken line.

For the envelope waveform D2, the sampling frequency Fs is less than twice the first frequency F1, and does not satisfy the sampling theorem. As a result, the envelope waveform Dx for which the sampling frequency Fs satisfies the sampling theorem and the envelope waveform D2 are different waveforms in the first section Z1. However, although the envelope waveform D2 is a waveform different from the envelope waveform Dx, the envelope waveform D2 keeps the feature that the vibration waveform appears at the repetition period Tr interval, similarly to the envelope waveform Dx.

That is, even the envelope waveform D2 that does not satisfy the sampling theorem includes the frequency component of the repetition frequency Fr that is the reciprocal of the repetition period Tr.

Next, the envelope detector 311 performs processing of, for example, taking an absolute value of a complex number for the envelope waveform D2 to generate an envelope waveform D3 (step S3).

Next, the frequency analyzer 312 performs offset removal processing for removing a DC component not to be analyzed from the envelope waveform D3 generated by the envelope detector 311, to thereby generate an analysis target waveform D4 (step S4). When a DC component (offset) exists in the envelope waveform D3, a strong peak over 0 to 2 Hz appears when the fast Fourier transform (FFT) in step S5 is performed. Therefore, even if a peak of 2 Hz or less due to a flaw in the rolling bearing B exists, it is not possible to determine whether the peak is due to the flaw or the offset, and there is a possibility that abnormality in the rolling bearing B cannot be determined.

Therefore, it is preferable that the frequency analyzer 312 performs the offset removal processing of step S4 to remove the DC component from the envelope waveform D3.

Next, the frequency analyzer 312 performs frequency analysis by fast Fourier transform (FFT) on the basis of the analysis target waveform D4 to calculate an analysis value D5 for each frequency component (step S5).

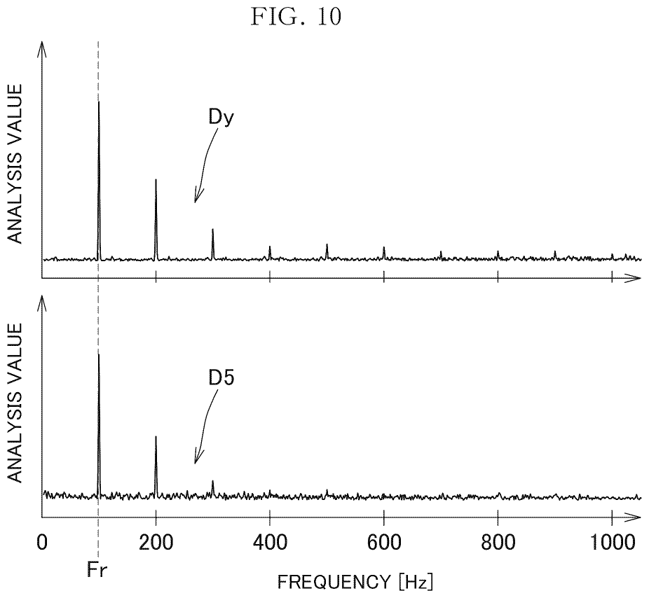

FIG. 10 is an explanatory diagram illustrating the analysis value D5 for each frequency component in a graph. FIG. 10 illustrates an analysis value Dy based on the envelope waveform Dx obtained when sampling is performed with the sampling frequency Fs set, as a compared target, to twice or more the first frequency F1.

As illustrated in FIG. 10, even in the analysis values D5 obtained when the sampling frequency Fs is less than twice the first frequency F1, i.e., when the sampling frequency Fs is in a state of undersampling, a peak appears at the repetition frequency Fr similarly to the analysis value Dy, for which the sampling frequency Fs is twice or more the first frequency F1 and satisfies the sampling theorem.

The frequency analyzer 312 may display the analysis value D5 for each frequency component on the display 33, for example, as a graph on a two-dimensional plane in which one axis represents the frequency and the other axis represents the analysis value as illustrated in FIG. 10. A user can detect abnormality in the rolling bearing B by viewing the graph of the analysis values D5 to check whether a peak appears at the repetition frequency Fr.

Next, the abnormality determiner 313 determines that the rolling bearing B is in an abnormal state, when the magnitude of the analysis value D5 for each frequency component exceeds a preset reference value within a reference frequency range that is a frequency range including the repetition frequency Fr. The reference value can be obtained, for example, experimentally and set as appropriate. The abnormality determiner 313 may display the determination result on the display 33.

The reference frequency range includes an outer ring frequency range including the repetition frequency Fr in a case where a flaw is generated in the outer ring B1, that is, an outer ring frequency range set in association with the outer ring B1, and an inner ring frequency range including the repetition frequency Fr in a case where a flaw is generated in the inner ring B2, that is, an inner ring frequency range set in association with the inner ring B2.

As the outer ring frequency range, for example, a value allowing for a measurement error of the vibration detection device 2, a calculation error of the envelope detector 311 and the frequency analyzer 312, and the like with respect to the repetition frequency Fr in a case where a flaw is generated in the outer ring B1 expressed by Expression (1) can be used. As the inner ring frequency range, for example, a value allowing for a measurement error of the vibration detection device 2, a calculation error of the envelope detector 311 and the frequency analyzer 312, and the like with respect to the repetition frequency Fr in a case where a flaw is generated in the inner ring B2 expressed by Expression (2) can be used.

The abnormality determiner 313 may determine that the outer ring B1 of the rolling bearing B is in an abnormal state when the magnitude of the analysis value D5 for each frequency component exceeds the reference value within the outer ring frequency range, and may determine that the inner ring B2 of the rolling bearing B is in an abnormal state when the magnitude of the analysis value D5 for each frequency component exceeds the reference value within the inner ring frequency range.

As described above, according to the vibration detection device 2 and the abnormality detection assistance system 1, it is possible to detect the abnormality in the rolling bearing B while causing the sampling frequency Fs to be in a state of undersampling, i.e., to be lower than twice the first frequency F1. As a result, the sampler 22 can be configured using an analog-digital converter or the like having a low sampling frequency Fs and thus being inexpensive. Therefore, it is easy to reduce the cost of the vibration detection device 2 that detects the abnormality in the rolling bearing B and the abnormality detection assistance system 1 using the vibration detection device 2.

Note that the abnormality detection assistance system 1 does not necessarily include the abnormality determiner 313. The envelope detector 311 may perform Hilbert transform (step S2) on the digital signal D without performing the offset removal processing (step S1). The envelope detector 311 only needs to be capable of acquiring the envelope, and the method of acquiring the envelope is not limited to the Hilbert transform.

The envelope detector 311 does not necessarily perform the processing of taking an absolute value of the complex number (step S3), and the frequency analyzer 312 may perform the offset removal processing (step S4) on the envelope waveform D2. The frequency analyzer 312 may perform the fast Fourier transform (step S5) on the envelope waveform D2 or the envelope waveform D3 without performing the offset removal processing (step S4).

That is, a vibration detection device according to an aspect of the present invention includes: a vibration detector that detects vibration generated in a rolling bearing and converts the vibration into an analog signal; and a sampler that performs sampling on the analog signal to convert the analog signal into a digital signal. In the vibration, a repeating unit including a first vibration section in which vibration occurs at a predetermined first frequency and a second section following the first vibration section is repeated at a predetermined repetition period, when a flaw is generated in the rolling bearing, and the sampler performs the sampling on the analog signal at a sampling frequency lower than twice the first frequency.

A vibration detection method according to an aspect of the present invention includes: detecting vibration generated in a rolling bearing and converting the vibration into an analog signal; and sampling the analog signal to convert the analog signal into a digital signal. In the vibration, a repeating unit including a first vibration section in which vibration occurs at a predetermined first frequency and a second section following the first vibration section is repeated at a predetermined repetition period, when a flaw is generated in the rolling bearing, and in the sampling, the analog signal is sampled at a sampling frequency lower than twice the first frequency.

According to these configurations, it is sufficient that sampling can be performed at a low frequency lower than twice the first frequency, so that an inexpensive member can be used as a member for performing sampling. As a result, it is easy to reduce the cost of the vibration detection device that detects the abnormality in the rolling bearing.

The sampling frequency is preferably lower than twice the first frequency.

According to this configuration, it is clear that sampling is performed at a low frequency that does not satisfy the sampling theorem with respect to the first frequency.

A period of the sampling is preferably shorter than ½ of the repetition period.

According to the configuration, the sampled digital signal includes a frequency component of the repetition frequency that is the reciprocal of the repetition period.

An abnormality detection assistance system according to an aspect of the present invention includes: a digital signal acquisitor that acquires the digital signal from the vibration detection device described above; an envelope detector that detects an envelope of a vibration waveform based on the digital signal; and a frequency analyzer that performs frequency analysis on the envelope to calculate an analysis value for each frequency component.

According to the configuration, an analysis value for each frequency component with respect to the envelope of the digital signal sampled at a low frequency lower than twice the first frequency is obtained. By obtaining the analysis value for each frequency component, it is easy to detect the abnormality in the rolling bearing from the analysis value.

It is preferable that the abnormality detection assistance system further includes an abnormality determiner that determines an abnormality when a magnitude of the analysis value for each frequency component exceeds a preset reference value in a reference frequency range that is a frequency range including a repetition frequency obtained by inverting the repetition period.

According to the configuration, it is possible to automatically detect abnormality in the rolling bearing.

It is preferable that the reference frequency range includes an outer ring frequency range set in association with an outer ring of the rolling bearing, and the abnormality determiner determines that the outer ring is abnormal when a magnitude of the analysis value for each frequency component exceeds the reference value within the outer ring frequency range.

According to the configuration, it is possible to automatically detect abnormality in the outer ring of the rolling bearing.

It is preferable that the reference frequency range includes an inner ring frequency range set in association with an inner ring of the rolling bearing, and the abnormality determiner determines that the inner ring is in an abnormal state when a magnitude of the analysis value for each frequency component exceeds the reference value within the inner ring frequency range.

According to this configuration, it is possible to automatically detect abnormality in the inner ring of the rolling bearing.

It is preferable that the abnormality detection assistance system further include the vibration detection device.

According to this configuration, the vibration detection device is included in the abnormality detection assistance system.

Note that the specific embodiment or example described in DESCRIPTION OF EMBODIMENTS merely clarifies the technical content of the present invention, and the present invention should not be interpreted in a narrow sense by limiting to such specific examples.

### REFERENCE SIGNS LIST

1 Abnormality detection assistance system
2 Vibration detection device
3 Abnormality detection assistance device
Acceleration sensor
21 Vibration detector
22 Sampler
23 Communicator
31 Calculator (digital signal acquisitor)
32 Communicator (digital signal acquisitor)
33 Display
311 Envelope detector
312 Frequency analyzer
313 Abnormality determiner
A Analog signal
A1 Repeating unit
B Rolling bearing
B1 Outer ring
B2 Inner ring
B3 Rolling element
D Digital signal
D1 Sampling waveform
D2, D3 Envelope waveform
D4 Analysis target waveform
D5 Analysis value
F1 First frequency
Fr Repetition frequency
Fs Sampling frequency
M Motor
Tr Repetition period
Ts Sampling period
Z1 First section
Z2 Second section

1: An abnormality detection assistance system comprising:
a vibration detector that detects vibration generated in a rolling bearing and converts the vibration into an analog signal;
a sampler that performs sampling on the analog signal to convert the analog signal into a digital signal;
an envelope-detector that detects an envelope of a vibration waveform based on the digital signal; and
a frequency analyzer that performs frequency analysis on the envelope to calculate an analysis value for each frequency component, wherein
in the vibration, a repeating unit including a first vibration section in which vibration occurs at a predetermined first frequency and a second section following the first vibration section is repeated at a predetermined repetition period, when a flaw is generated in the rolling bearing, and
the sampler performs the sampling, without taking a measure for preventing folding, on the analog signal at a sampling frequency lower than twice the first frequency to convert the analog signal into the digital signal containing folding noise.

2: The abnormality detection assistance system according to claim 1, wherein a period of the sampling is shorter than ½ of the repetition period.

3. (canceled)

4: The abnormality detection assistance system according to claim 1, further comprising:
an abnormality determiner that determines an abnormality when a magnitude of the analysis value for each frequency component exceeds a preset reference value in a reference frequency range that is a frequency range including a repetition frequency obtained by inverting the repetition period.

5: The abnormality detection assistance system according to claim 4, wherein
the reference frequency range includes an outer ring frequency range set in association with an outer ring of the rolling bearing, and
the abnormality determiner determines that the outer ring is in an abnormal state when a magnitude of the analysis value for each frequency component exceeds the reference value within the outer ring frequency range.

6: The abnormality detection assistance system according to claim 4, wherein
the reference frequency range includes an inner ring frequency range set in association with an inner ring of the rolling bearing, and
the abnormality determiner determines that the inner ring is in an abnormal state when a magnitude of the analysis value for each frequency component exceeds the reference value within the inner ring frequency range.

7: A vibration detection device to be used in the abnormality detection assistance system according to claim 1, the vibration detection device comprising:
the vibration detector; and
the sampler.

8: A vibration detection device comprising:
a vibration detector that detects vibration generated in a rolling bearing and converts the vibration into an analog signal; and
a sampler that performs sampling on the analog signal to convert the analog signal into a digital signal, wherein
in the vibration, a repeating unit including a first vibration section in which vibration occurs at a predetermined first frequency and a second section following the first vibration section is repeated at a predetermined repetition period, when a flaw is generated in the rolling bearing, and
the sampler performs the sampling, without taking a measure for preventing folding, on the analog signal at a sampling frequency lower than twice the first frequency to convert the analog signal into the digital signal containing folding noise.

9: A vibration detection method comprising:
detecting vibration generated in a rolling bearing and converting the vibration into an analog signal; and
sampling the analog signal to convert the analog signal into a digital signal, wherein
in the vibration, a repeating unit including a first vibration section in which vibration occurs at a predetermined first frequency and a second section following the first vibration section is repeated at a predetermined repetition period, when a flaw is generated in the rolling bearing, and
in the sampling, the analog signal is sampled, without taking a measure for preventing folding, at a sampling frequency lower than twice the first frequency to convert the analog signal into the digital signal containing folding noise.
